(19) United States
(12) Patent Application Publication
(10) Pub. No.: US 2025/0335274 A1
(43) Pub. Date: Oct. 30, 2025

(54) APPLICATION PROGRAMMING INTERFACE MANAGEMENT IN AN INFORMATION PROCESSING SYSTEM

(71) Applicant: Dell Products L.P., Round Rock, TX (US)

(72) Inventors: Shibi Panikkar, Bangalore (IN); Vibha Pandey, Bangalore (IN); Dhilip S. Kumar, Bangalore (IN)

(21) Appl. No.: 18/650,517

(22) Filed: Apr. 30, 2024

(51) Int. Cl. G06F 9/54

(52) U.S. Cl. CPC G06F 9/547

(57) ABSTRACT

Techniques for application programming interface management in information processing systems are disclosed. For example, a method obtains data associated with one or more users indicative of interactions of the one or more users with an application programming interface configured to enable the one or more users to interact with an information processing system. The method computes a score for the application programming interface based on at least a portion of the obtained data, the computed score is indicative of a maturity level of the application programming interface. In some further examples, the data may correspond to factors in one or more categories (e.g., model layers) of user interaction with the application programming interface such that, as data corresponding to one or more of the factors changes, the score indicative of the maturity level of the application programming interface changes. The score may be used to modify the application programming interface.

### FIELD

The field relates generally to information processing systems, and more particularly to techniques for application programming interface management in such information processing systems.

### BACKGROUND

Digital commerce systems, e.g., information processing systems configured to enable buyers (e.g., customers) and sellers (e.g., manufacturers/vendors or, more generally, enterprises) to conduct transactions over a computer network, have become the ubiquitous form of interaction between such entities. Furthermore, in the manufacturing industry, for example, such digital commerce systems also typically include applications that are made available by original equipment manufacturers (OEMs) to customers. Such applications have application programming interfaces (APIs) which are connectivity mechanisms for applications. For example, an API is configured to exchange data between applications or between applications and devices of entities (e.g., users or, for example in the digital commerce use case, clients or customers) using the applications.

In a manufacturer-client scenario (e.g., OEM and its customers), client/customer experience can be directly affected by APIs, and thus an OEM can lose credibility based on its APIs. In a scenario where an application communicates with one or more public APIs in order to interact with providers and obtain data, as well as develop new content, the API should be mature (e.g., sufficiently developed, sufficiently configured, etc.) enough to provide the data. There are existing models and frameworks that can be used to assess an API maturity level, such as the Richardson maturity model, the API capability maturity model, and the API lifecycle maturity model. However, these existing API maturity models have technical drawbacks.

Such technical drawbacks can have adverse technical effects with respect to resources of the underlying distributed computer network on which the digital commerce system resides and executes. For example, computer processing delays, data storage shortages, and/or communication network congestion occurs, especially when deficient APIs cause additional resources in the digital commerce system to be needed.

### SUMMARY

Illustrative embodiments provide techniques for application programming interface management in information processing systems. While techniques illustratively described herein are particularly well-suited for digital commerce systems, the application programming interface management techniques are more broadly applicable to a wide variety of other information processing systems.

For example, in one or more illustrative embodiments, a method obtains data associated with one or more users indicative of interactions of the one or more users with an application programming interface configured to enable the one or more users to interact with an information processing system. The method computes a score for the application programming interface based on at least a portion of the obtained data, wherein the computed score is indicative of a maturity level of the application programming interface.

In some illustrative embodiments, the data may correspond to factors in one or more categories (e.g., model layers) of user interaction with the application programming interface such that, as data corresponding to one or more of the factors changes, the score indicative of the maturity level of the application programming interface changes.

These and other illustrative embodiments include, without limitation, methods, apparatus, networks, systems and processor-readable storage media.

### BRIEF DESCRIPTION OF THE DRAWINGS

FIG. 1 illustrates an information processing system in which application programming interface management functionalities according to one or more illustrative embodiments can be implemented.

FIG. 2 illustrates an application programming interface management architecture according to an illustrative embodiment.

FIG. 3 illustrates a use case associated with application programming interface management according to an illustrative embodiment.

FIG. 4 illustrates another use case associated with application programming interface management according to an illustrative embodiment.

FIG. 5 illustrates yet another use case associated with application programming interface management according to an illustrative embodiment.

FIG. 6 illustrates an application programming interface management methodology according to an illustrative embodiment.

FIGS. 7 and 8 illustrate examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, processing systems comprising compute, storage and/or network resources, other types of processing systems comprising various combinations of physical and/or virtual resources, as well as other types of distributed computer networks.

It is realized herein that API maturity should describe how advanced and effective an API is in terms of various attributes. API maturity can help an enterprise evaluate the quality and value of its APIs, as well as identify areas for improvement. As mentioned, there are different models and frameworks that can be used to assess API maturity level, such as the Richardson maturity model, the API capability maturity model, and the API lifecycle maturity model.

However, it is further realized herein that an API maturity score computed with one of the above-mentioned existing models is static in nature because of the features the score is typically based on. For example, existing ALP maturity models typically rely solely on static features such as documentation, best practices, software development and operations (devops), deployment traction, etc. Thus, if the ongoing service of the API deteriorates, there is no way to reduce the API maturity score to reflect the degradation. Likewise, if the API is performing exceptionally well, there is no way to increase the API maturity score to reflect the effectiveness.

For example, assume a first API has a maturity score of “A” (using a letter scale of A-F with A being the best score and F being the worst) because it is well-documented, has high devops maturity, etc. However, when a user interacts with the first API, assume the performance drops off and there is no consistent response. Further assume, a second API has strong performance, is highly available, and gives consistent results. However, the second API has low devops maturity and a maturity score of “C.” This example illustrates the technical drawback for users relying on existing API maturity models to rate the APIs as to which API, the first or the second, is a better selection for the user.

Furthermore, it is further realized herein that an API is more than just an application interface, it can be considered an experience. That is, the API is the consumer experience in a modern API-driven culture (e.g., APIs associated with applications that comprise a digital commerce system) and it should preferably be highly accessible, consistent, accurate, and of high quality. Customers purchase commodity/hardware items such as phones, computers, and other electronic devices based on their quality and pricing. The pricing is also determined by the vendor based on the product quality. Before they buy, they test, measure, and assess the price. The API can also be considered a product. It is thus desirable for an API platform to provide a way to more effectively calculate the maturity level of an API, and thus the quality of the API.

Illustrative embodiments provide a dynamic API maturity model based on several factors of the API comprising data consistency, performance, user feedback driven along with producer measures, etc. In the case of the manufacturing digital commerce use case, the producer is the OEM or other enterprise and the user is a customer or client of the OEM or other enterprise. The dynamic API maturity model according to illustrative embodiments is based on default and configurable coefficient layers (categories) which allow users to inspect and evaluate the API's quality before consuming it (as illustratively used herein, a customer or client that uses an API may also be referred to a consumer). The dynamic maturity model according to illustrative embodiments is based on the quality of the API and customer satisfaction and the maturity will vary based on that, even if the data quality varies depending on the use.

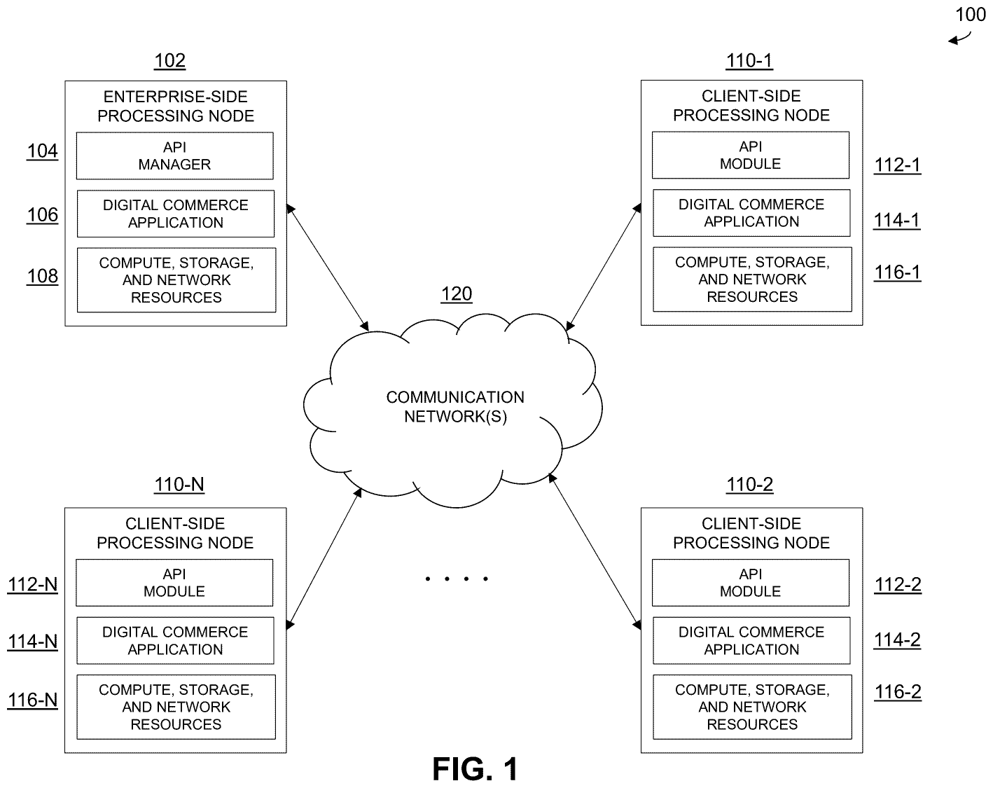

Referring initially to FIG. 1, an information processing system 100 is depicted in which API management functionalities using a dynamic API maturity model according to one or more illustrative embodiments can be implemented. As shown, information processing system 100 includes an enterprise-side processing node 102 and client-side processing nodes 110-1, 110-2, . . . , 102-N (may hereinafter each individually be referred to as client-side processing node 110 or collectively as client-side processing nodes 110). Enterprise-side processing node 102 and client-side processing nodes 110 are operatively coupled to one another via one or more communication networks 120.

As further shown, enterprise-side processing node 102 comprises an API manager 104, a digital commerce application 106, and a set of compute, storage, and network resources 108. Client-side processing node 110-1 comprises an API module 112-1, a digital commerce application 114-1, and a set of compute, storage, and network resources 116-1. Client-side processing node 110-2 comprises an API module 112-2, a digital commerce application 114-2, and a set of compute, storage, and network resources 116-2. Client-side processing node 110-N comprises an API module 112-N, a digital commerce application 114-N, and a set of compute, storage, and network resources 116-N. API modules 112-1, 112-2, . . . , 112-N may hereinafter each individually be referred to as API module 112 or collectively as API modules 112. Digital commerce applications 114-1, 114-2, . . . , 114-N may hereinafter each individually be referred to as digital commerce application 114 or collectively as digital commerce applications 114. Sets of compute, storage, and network resources 116-1, 116-2, . . . , 116-N may hereinafter each individually be referred to as set of compute, storage, and network resources 116 or collectively as sets of compute, storage, and network resources 116.

In some embodiments, information processing system 100 may be considered a digital commerce system. By way of example only, in the above-mentioned OEM/customer scenario, assume enterprise-side processing node 102 is associated with the OEM and client-side processing nodes 110 are respectively associated with customers. Digital commerce application 114 running on each client-side processing node 110 provides general digital commerce functions (e.g., product/service offerings, selection, procurement, etc.) that are managed by digital commerce application 106 in enterprise-side processing node 102. API module 112 in each client-side processing node 110 provides client-side API functions to enable access to the digital commerce functions. API manager 104 in enterprise-side processing node 102 provides server-side API functions as well as API management including dynamic API maturity model functionalities as will be further described herein.

In some embodiments, server-side API functions handle backend interactions such as data processing and database interactions, while client-side API functions enable user (e.g., customer) interactions, data presentation, and communication with the server-side API to obtain and send data. Collectively, the server-side API functions (e.g., part of API manager 104) and the client-side API functions (e.g., part of API module 112) facilitate communication and functionality within and/or between applications (e.g., digital commerce applications 106 and 114). Further, the set of compute, storage, and network resources 108 in enterprise-side processing node 102 and the sets of compute, storage, and network resources 116 respectively in client-side processing nodes 110 may then collectively comprise what is mentioned herein as the resources of the underlying computer system upon which the digital commerce system resides and executes.

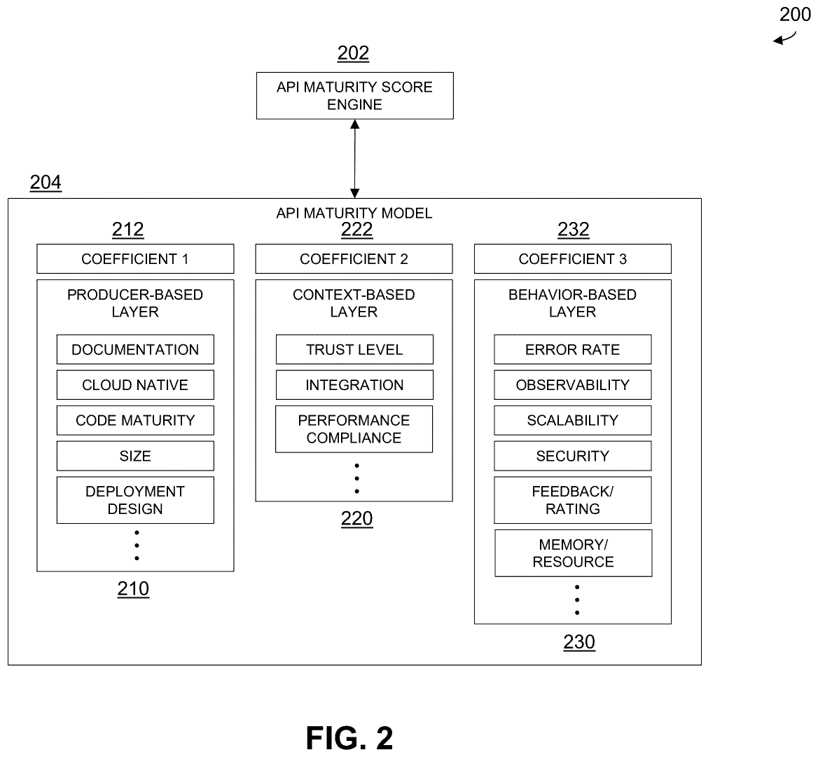

API manager 104 in enterprise-side processing node 102 is configured with API management functionalities including dynamic API maturity correction as will be further described in the context of FIG. 2. In some embodiments, an API maturity model according to one or more illustrative embodiments is a layered approach, e.g., the model comprises multiple layers: (i) a producer-based layer that accounts for a first coefficient value; (ii) a context-based layer that accounts for a second coefficient value; and (iii) a behavior-based layer that accounts for a third coefficient value. It is to be appreciated that the producer-based layer functions as a default or static layer taking into account enterprise-driven considerations in the API maturity score computation. However, the context-based layer and the behavior-based layer are considered dynamic layers and take into account customer-driven considerations in the API maturity score computation so as to correct the API maturity score based on one or more changing factors as will be further described herein.

By way of example, in some embodiments, the producer-based layer calculates a coefficient value for design, development, and deployment based on, for example, one or more of API documentation, programming language/sustainable features, platform dependency, cloud native design, size, response, dependence on latest version, frequent changes, version maintenance, and deployment design (blue/green). Further, in some embodiments, the context-based layer calculates a coefficient value based on customer-perspective API factors including, for example, one or more of how well the API is meeting expectations, whether the API is a trusted source/accurate, and ease of consumption of the API. Still further, the behavior-based layer calculates a coefficient value based on customer-perspective API factors including, for example, one or more of customer feedback, memory/resource consumption, error management, availability, security, scalability, service-level-agreement (SLA)/response metrics, and self-healing capabilities. It is to be understood that in the context of FIG. 1, each API module 112 in each client-side processing node 110 can provide data indicative of the above-mentioned customer-perspective API factors to API manager 104 in enterprise-side processing node 102 to enable API manager 104 to compute an API maturity score based on the coefficients respectively calculated for each of the three layers. In some embodiments, the coefficients are configured based on the API's production behavior and are accumulated.

Referring now to FIG. 2, an API management system architecture 200 according to an illustrative embodiment is depicted. By way of example only, in some embodiments, API management system architecture 200 (hereinafter, simply, system architecture 200) can be implemented by API manager 104 in enterprise-side processing node 102 of FIG. 1. In some other embodiments, one or more API management functionalities can be implemented in one or more of API modules 112 of client-side processing nodes 110. Still further, in other embodiments, one or more API management functionalities can be implemented in another processing platform separate from, but operatively connected to, one or more of enterprise-side processing node 102 and client-side processing nodes 110.

As shown in FIG. 2, system architecture 200 includes an API maturity score engine 202 that executes an API maturity model 204. API maturity model 204 includes a producer-based layer 210, a context-based layer 220, and a behavior-based layer 230, as described above. API maturity score engine 202 calculates a coefficient (value) for each of the three layers based on factors associated with each layer. Thus, for producer-based layer 210, a coefficient 212 (coefficient 1) is calculated from factors (e.g., features) such as, but not limited to, documentation, cloud native design, code maturity, API size, and API deployment design. For context-based layer 220, a coefficient 222 (coefficient 2) is calculated from factors such as, but not limited to, trust level, integration, and performance compliance. For behavior-based layer 230, a coefficient 232 (coefficient 3) is calculated from factors such as, but not limited to, error rate, observability, scalability, security, feedback/rating, and memory resource utilization. Note that the factors shown in FIG. 2 for each of the layers are examples and thus, in other embodiments, less of these factors, other factors, and/or a combination thereof, can be utilized to compute an API maturity score.

Consider one example use case for which system architecture 200 can be implemented. Assume an enterprise operates in accordance with a digital commerce system and is, thus, an API-driven enterprise since transactions with customers occur through the APIs made available by the enterprise across the digital commerce system (e.g., digital commerce applications 106 and 114). Assume that the digital commerce system has functionalities to enable customers to perform online operations (e.g., advanced payment, usage-based payment, subscription-based payment, etc.). In existing API systems, customers are compelled to choose these options without knowledge of the API quality. However, as realized herein, it is desirable to have a high-quality API in order to generate more precise transactions which would result in, inter alia, improved operations and application decision-making. This is the case, particularly with respect to resources of the underlying distributed computer network on which the digital commerce system resides and executes (e.g., compute, storage, and network resources 108 and 116). For example, computer processing delays, data storage shortages, and/or communication network congestion occur, especially when inadequate APIs cause additional resources in the digital commerce system to be needed.

It is to be understood that the definition of API quality may vary based on diverse factors such as, but not limited to, data source, API availability, API load balancing, integration options and ease of use, business relevance, performance/SLA, etc. However, a desired objective is to enable an accurate transaction and decisions that can aid in providing meaningful insights. Illustrative embodiments realize that while producers (i.e., enterprises) can set the value of their APIs, the API users (i.e., clients or customers) are best positioned for determining API quality. Accordingly, system architecture 200 is configured to correct producer-driven (static) metrics by accounting for customer-driven (dynamic) metrics. In some embodiments, static metrics can be derived upon onboarding of data based on a set of rules and weightage in different categories, while correction with dynamic metrics can be based on different errors and issues reported by the consumers while using the API (e.g., multiple customers using the same API), as will be further explained below. System architecture 200 collects the errors and issues reported by customers, categorizes the errors and issues, and based on the density of errors and issues reported, applies dynamic correction to the API maturity score.

Maturity coefficients are part of the API maturity paradigm according to one or more illustrative embodiments. As shown in FIG. 2, the coefficients 212, 222, and 232 are calculated based on factors associated with their respective layers. In some embodiments, the maturity score of an API can be represented via a numerical scale, e.g., 1 to 10 with 1 being the lowest API maturity score and 10 being the highest.

In some embodiments, the coefficient values can be considered percentages that affect the API maturity score. Assume coefficient 212 defines a specific maturity (constant) for a producer-based layer (category) 210 and is 25%. Assume further then that coefficients 222 and 232 each define dynamic maturity that can vary between two thresholds defined based on the density of the errors or issues in each respective layer (category) 220 or 230 and are each 37.5%. Thus, when coefficient 212 is 25% and each of coefficients 222 and 232 are 37.5% for a total of 100%, the API maturity score is 10. However, if any of the coefficients are reduced, the total percentage that affects the API maturity score will decrease. Accordingly, in some embodiments, the API maturity score varies based on how the consumer uses the product.

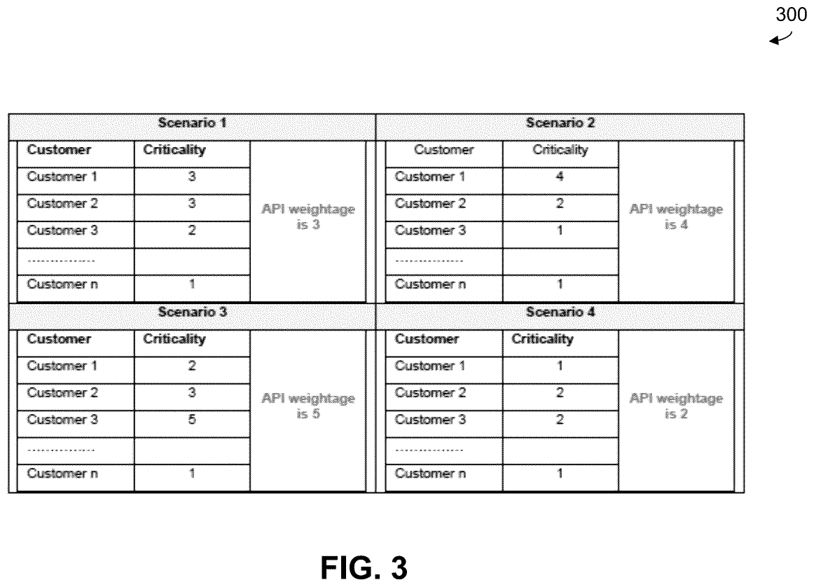

Furthermore, in some embodiments, the value of the API's dynamic behavior is affected by a weighting parameter, e.g., API weightage, determined across the multiple customers. Assume the API weightage can range between 1 (minimum weightage) and 5 (maximum weightage). API maturity score engine 202 requests from each of the customers (client-side processing nodes 110) an API criticality value selected from a range between 1 and 5. Assume at least one customer indicates that the criticality of an API is 5, then the API weightage is 5. If no customers selected 5 or 4, but some number of customers selected 3, then the API weightage is 3. In this non-limiting example, the API weightage is set to be the highest criticality value received from any one customer. This is shown in table 300 of FIG. 3.

In each scenario listed in table 300, the API's weighting is determined by the customer's highest priority. In scenario 1, customers 1 and 2 set their priority to 3, and other customers set their priority to less than 3, so the API weightage in scenario 1 is 3. In scenario 2, customer 1specified priority level 4, consequently, the API weightage is 4. In a similar fashion, the API weightage for scenario 3 is 5, and for scenario 4, it is 2. Thus, in some embodiments:

API weightage=Max (highest provided weightage for that parameter)

Computation of coefficient 232 (behavior-based layer) will now be illustratively described. The sum of each parameter coefficient multiplied with the API's weightage as determined above provides a complete behavioral coefficient 232. Below is an example formula to determine the coefficient:

$${\sum }_{{i = 1}_{j = 1}}^{5} {x}_{i} ( {y}_{j} + {z}_{j} )$$

y and z represent the parameter coefficient for various attributes listed in the behavior-based layer 230;

x represents the API's weightage for each of the parameters These weights can be determined according to the API priority specified by the consumer/customer, as described above;

y is calculated with a rate ratio. For the behavior-based layer, some of the parameters are calculated with a rate ratio and others are based on a consumer set value. For example, for error management, availability, security, and SLA, the rate ratio is the number of times the API successfully responded and the total hits given in a period of time.

Hence, y=Positive value of parameter/Total API Hits−Rate Ratio Scenario

z is a direct input from the customer with percentage 1 to 100% with 1 being low and 100 being the highest.

$$Rate Ratio coefficient = ( scalability coeff * weightage ) + ( security coeff * weightage ) + ( success response coeff * weightage ) + ( self - healing coeff * weightage ) + ( sla coeff * weightage ) \\ Direct Ratio Coefficient = \frac{\sum {c}_{i}}{N} * weightage \\ c = Customer feedback / 100 \\ N = Total Customers \\ Behavioral coefficient = Rate Ratio coefficient + Direct Ratio Coefficient$$

Consider the following example to calculate each coefficient.

Total API call is 450, out of which:

$$Scalability = 450 ; \\ Security = 450 ; \\ Success response = 440 ; \\ Self - healing = 450 ; \\ and \\ S L A = 435. \\ Rate Ratio coefficient = ( 450 / 450 ) * 5 + ( 450 / 450 ) * 5 + ( 440 / 450 ) * 5 + ( 450 / 450 ) * 5 + ( 435 / 450 ) * 5 ; \\ Rate Ratio coefficient = 1 * 5 + 1 * 5 + \text{.98} * 5 + 1 * 5 + \text{.97} * 5 ; \\ Rate Ratio coefficient = 15 + 4.9 + 4.85 ; \\ Rate Ratio coefficient = 24.75 ; \\ Ideal total score is 25 ( sum of all weightages ) ; \\ Rate Ratio coefficient = ( 24.75 / 25 ) * 100 ; \\ Rate Ratio coefficient = 0.99 .$$

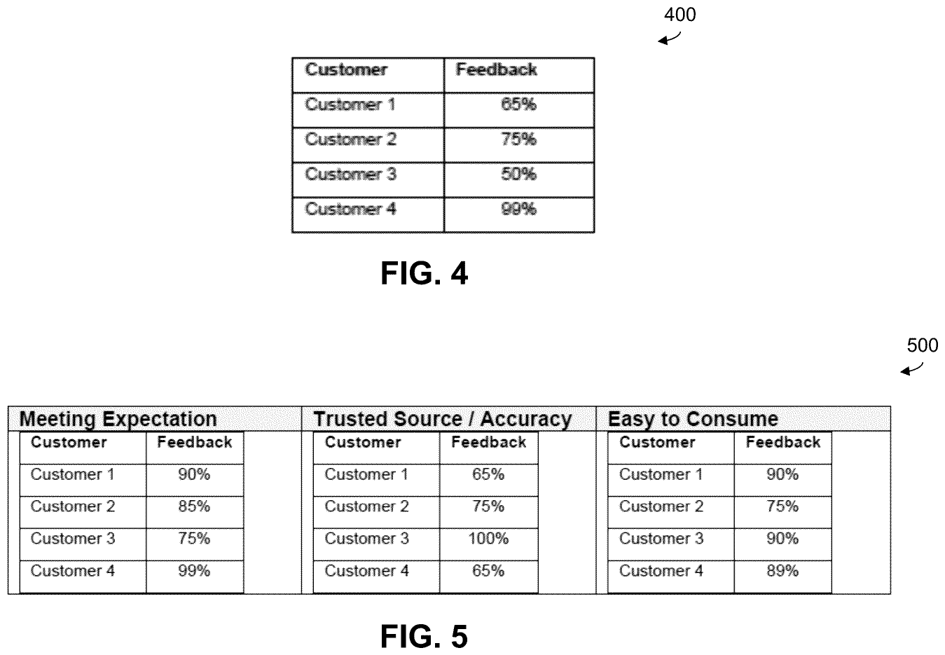

A direct ratio coefficient is illustrated below. Table 400 in FIG. 4 illustrates customer feedback.

$$Direct Ratio Coefficient = ( 65 / 100 ) + ( 75 / 100 ) + ( 50 / 100 ) + ( 99 / 100 ) / 4 ) ; \\ Direct Ratio Coefficient = 0.7 . \\ Thus , the behavior - based layer coefficient = 37.5 \% * ( ( \text{.99} + 0.7 ) / 2 ) = 0.316875 ( 31.6875 \% ) .$$

Computation of coefficient 222 (context-based layer or business context as illustrated below) will now be illustratively described.

Since the business context coefficient is directly related to customer feedback, the value can be computed as:

$$Business Context Coefficient = \sum \frac{\frac{\sum {b}_{i}}{n}}{N}$$

b is business context of different customers;

n is the total number of customers; and

N is total business contexts.

Assume there are four customers who provide the feedback on each of the parameters.

Thus, the calculation is:

$$Meeting Expectation ( e . g . , performance compliance ) = ( 90 \% + 85 \% + 75 \% + 99 \% ) / 4 ; \\ Trusted Source / Accuracy = ( 65 \% + 75 \% + 100 \% + 65 \% ) / 4 ; \\ Easy to Consume = ( 90 \% + 75 \% + 90 \% + 89 \% ) / 4 ; \\ Business Context Coefficient = ( 88 \% + 70 \% + 90 \% ) / 3 ; \\ Business Context Coefficient = 88 \% ; \\ Business Context Coefficient = 37.5 \% * 88 \% ; \\ and \\ Business Context Coefficient = 0.328125 ( 32.8125 \% ) .$$

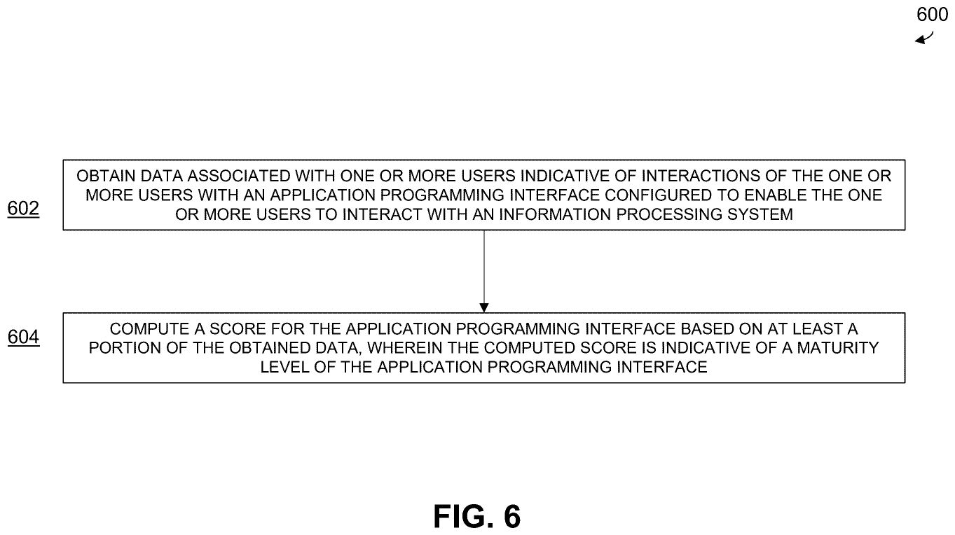

Table 500 in FIG. 5 illustrates data for the above context-based layer coefficient computation example.

Now to compute the API maturity score:

All three coefficients are added into the API maturity score and divided by 10 to get the ratings: (Static Coefficient +Business Context Coefficient +Dynamic Coefficient) * 10;

$$A P I Maturity = ( 0.2 5 + 0.328125 + 0.3168 \; 75 ) * 10 ; \\ and \\ A P I Maturity = 8.95 .$$

Thus, assuming 10 is the highest API maturity score, illustrative API management techniques described herein correct the API maturity score to 8.95 to give a more accurate representation of the API's maturity level after taking int account customer-driven factors.

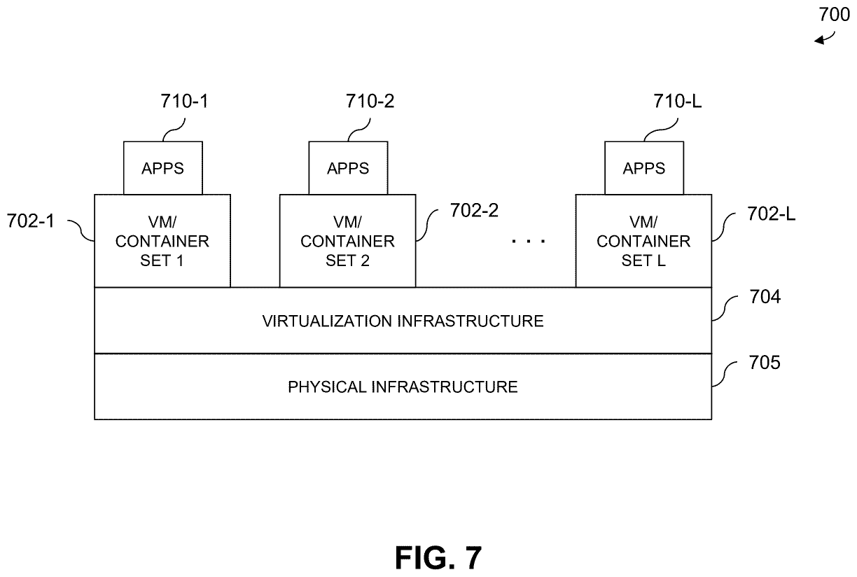

FIG. 6 illustrates an application programming interface management methodology 600 according to an illustrative embodiment. As shown, step 602 obtains data associated with one or more users indicative of interactions of the one or more users with an application programming interface configured to enable the one or more users to interact with an information processing system. Step 604 computes a score for the application programming interface based on at least a portion of the obtained data, wherein the computed score is indicative of a maturity level of the application programming interface.

In some embodiments, the data corresponds to factors in one or more categories (e.g., model layers) of user interaction with the application programming interface such that, as data corresponding to one or more of the factors changes, the score indicative of the maturity level of the application programming interface changes.

In some embodiments, the one or more categories comprise a behavior category and a context category.

In some embodiments, a dynamic coefficient is computed for each of the one or more categories such that each dynamic coefficient contributes to the score indicative of the maturity level of the application programming interface.

In some embodiments, a weightage is applied to the dynamic coefficient computed for each of the one or more categories, wherein the weightage is derived from one or more criticality values received from the one or more users.

In some embodiments, a fixed coefficient is computed based on factors associated with the provider of the application programming interface such that the fixed coefficient also contributes to the score indicative of the maturity level of the application programming interface.

In some embodiments, each dynamic coefficient of the one or more categories are used to correct the fixed coefficient.

In some embodiments, the data corresponding to the factors in one or more categories of user interaction with the application programming interface is continuously obtained from feedback and error reporting by the one or more users.

In some embodiments, the score is utilized to modify the application programming interface to reduce a burden on one or more computing resources associated with the information processing system. By way of example, this API modification can be done by enterprise-side processing node 102 and/or some other processing platform.

In some embodiments, the information processing system comprises a digital commerce system.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

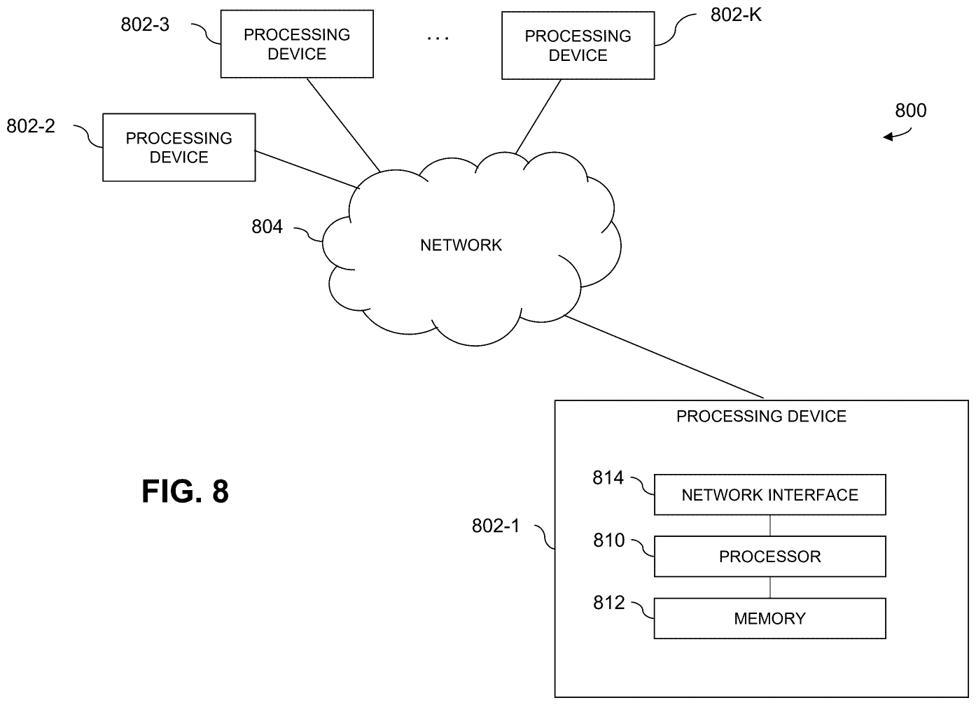

Illustrative embodiments of processing platforms utilized to implement functionality for application programming interface management will now be described in greater detail with reference to FIGS. 7 and 8. Although described in the context of the information processing system environments mentioned herein, these platforms may also be used to implement at least portions of other information processing systems in other embodiments.

FIG. 7 shows an example processing platform comprising infrastructure 700. Infrastructure 700 comprises a combination of physical and virtual processing resources that may be utilized to implement at least a portion of the information processing system 100 in FIG. 1.

Infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

Infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 may comprise respective VMs, respective sets of one or more containers, or respective sets of one or more containers running in VMs.

In some implementations of the FIG. 7 embodiment, the VMs/container sets 702 comprise respective VMs implemented using virtualization infrastructure 704 that comprises at least one hypervisor. A hypervisor platform may be used to implement a hypervisor within the virtualization infrastructure 704, where the hypervisor platform has an associated virtual infrastructure management system. The underlying physical machines may comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of information processing system environments mentioned herein may each run on a computer, server, storage device or other processing platform element. A given such element may be viewed as an example of what is more generally referred to herein as a “processing device.” Infrastructure 700 shown in FIG. 7 may represent at least a portion of one processing platform. Another example of such a processing platform is processing platform 800 shown in FIG. 8.

The processing platform 800 in this embodiment comprises at least a portion of the information processing systems described herein and includes a plurality of processing devices, denoted 802-1, 802-2, 802-3, . . . 802-K, which communicate with one another over a network 804.

The network 804 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 802-1 in the processing platform 800 comprises a processor 810 coupled to a memory 812.

The processor 810 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 812 may comprise random access memory (RAM), read-only memory (ROM), flash memory or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and information processing system environments mentioned herein may include additional or alternative processing platforms, as well as numerous distinct processing platforms in any combination, with each such platform comprising one or more computers, servers, storage devices or other processing devices. For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for application monitoring with predictive anomaly detection and fault isolation as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, edge computing environments, applications, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing platform comprising at least one processor coupled to at least one memory, the at least one processing platform, when executing program code, is configured to:
manage an application programming interface configured to enable one or more users to interact with an information processing system, wherein, when managing the application programming interface, the at least one processing platform is further configured to:
obtain data associated with the one or more users indicative of interactions of the one or more users with the application programming interface; and
compute a score for the application programming interface based on at least a portion of the obtained data, wherein the computed score is indicative of a maturity level of the application programming interface.

2. The apparatus of claim 1 wherein the data corresponds to factors in one or more categories of user interaction with the application programming interface such that, as data corresponding to one or more of the factors changes, the score indicative of the maturity level of the application programming interface changes.

3. The apparatus of claim 2 wherein the one or more categories comprise a behavior category and a context category.

4. The apparatus of claim 2 wherein a dynamic coefficient is computed for each of the one or more categories such that each dynamic coefficient contributes to the score indicative of the maturity level of the application programming interface.

5. The apparatus of claim 4 wherein a weightage is applied to the dynamic coefficient computed for each of the one or more categories, wherein the weightage is derived from one or more criticality values received from the one or more users.

6. The apparatus of claim 4 wherein a fixed coefficient is computed based on factors associated with a provider of the application programming interface such that the fixed coefficient also contributes to the score indicative of the maturity level of the application programming interface.

7. The apparatus of claim 6 wherein each dynamic coefficient of the one or more categories are used to correct the fixed coefficient.

8. The apparatus of claim 2 wherein the data corresponding to the factors in one or more categories of user interaction with the application programming interface is continuously obtained from feedback and error reporting by the one or more users.

9. The apparatus of claim 1 wherein, when managing the application programming interface, the at least one processing platform is further configured to utilize the score to modify the application programming interface to reduce a burden on one or more computing resources associated with the information processing system.

10. The apparatus of claim 1 wherein the information processing system comprises a digital commerce system.

11. A method comprising:
obtaining data associated with one or more users indicative of interactions of the one or more users with an application programming interface configured to enable the one or more users to interact with an information processing system; and
computing a score for the application programming interface based on at least a portion of the obtained data, wherein the computed score is indicative of a maturity level of the application programming interface.

12. The method of claim 11 wherein the data corresponds to factors in one or more categories of user interaction with the application programming interface such that, as data corresponding to one or more of the factors changes, the score indicative of the maturity level of the application programming interface changes.

13. The method of claim 12 wherein the one or more categories comprise a behavior category and a context category.

14. The method of claim 12 wherein a dynamic coefficient is computed for each of the one or more categories such that each dynamic coefficient contributes to the score indicative of the maturity level of the application programming interface.

15. The method of claim 14 wherein a weightage is applied to the dynamic coefficient computed for each of the one or more categories, wherein the weightage is derived from one or more criticality values received from the one or more users.

16. The method of claim 14 wherein a fixed coefficient is computed based on factors associated with a provider of the application programming interface such that the fixed coefficient also contributes to the score indicative of the maturity level of the application programming interface.

17. The method of claim 16 wherein each dynamic coefficient of the one or more categories are used to correct the fixed coefficient.

18. The method of claim 12 wherein the data corresponding to the factors in one or more categories of user interaction with the application programming interface is continuously obtained from feedback and error reporting by the one or more users.

19. A computer program product comprising a non-transitory processor-readable storage medium having stored therein program code of one or more software programs, wherein the program code when executed by at least one processing platform causes the at least one processing platform to:
manage an application programming interface configured to enable one or more users to interact with an information processing system, wherein, when managing the application programming interface, the at least one processing platform is further configured to:
obtain data associated with the one or more users indicative of interactions of the one or more users with the application programming interface; and
compute a score for the application programming interface based on at least a portion of the obtained data, wherein the computed score is indicative of a maturity level of the application programming interface.

20. The computer program product of claim 19 wherein the data corresponds to factors in one or more categories of user interaction with the application programming interface such that, as data corresponding to one or more of the factors changes, the score indicative of the maturity level of the application programming interface changes.
